(19) United States
(12) Patent Application Publication
(10) Pub. No.: US 2014/0162685 A1
(43) Pub. Date: Jun. 12, 2014

(54) DISCOVERY AND SUPPORT OF PROXIMITY

(71) Applicant: QUALCOMM INCORPORATED, San Diego, CA (US)

(72) Inventor: Stephen William EDGE, Escondido, CA (US)

(73) Assignee: QUALCOMM Incorporated, San Diego, CA (US)

(21) Appl. No.: 13/844,410

(22) Filed: Mar. 15, 2013

Related U.S. Application Data
(60) Provisional application No. 61/735,490, filed on Dec. 10, 2012.

(51) Int. Cl. H04W 4/02

(52) U.S. Cl. CPC H04W 4/023
USPC 455/456.1

(57) ABSTRACT

Systems, apparatus and methods for proximity determination between transceivers, such as mobile devices, are presented. Proximity may be a logical combination of geographic proximity, radio proximity and/or cellular proximity. Proximity may be determined using a low overhead coarse test followed by a more intensive accurate test. Proximity may be determined indirectly via one or more intermediary transceivers having a predetermined relationship.

### CROSS-REFERENCE TO RELATED APPLICATIONS

This application claims the benefit of and priority under 35 U.S.C. §119(e) to U.S. Provisional Application No. 61/735,490, filed Dec. 10, 2012, entitled “Discovery and support of proximity,” and which is assigned to the assignee hereof and incorporated herein by reference in its entirely.

### BACKGROUND

I. Field of the Invention

This disclosure relates generally to systems, apparatus and methods for wirelessly determining proximity, and more particularly to using geographic proximity; radio proximity and/or cellular proximity to determine when two or more mobile devices are within proximate of each other.

II. Background

A variety of applications such as tracking applications, friend finder applications and proximity alert applications utilize a concept of proximity of a particular device. Traditionally, applications determine proximity through ongoing periodic detection and acquisition of global navigation satellite system (GNSS) signals to calculate GNSS-based location results, a process that consumes significant power, which can result in decreased battery life when applications have been used.

### BRIEF SUMMARY

Disclosed is an apparatus and method for determining proximity of two or more transceivers. According to some aspects, disclosed is a method, on a mobile device, to determine a combined proximity result for two transceivers, the method comprising: determining results for at least two types of proximity from a group comprising: geographic proximity; radio proximity; and cellular proximity; and determining the combined proximity result by logically combining the results for the at least two types of proximity.

According to some aspects, disclosed is a mobile device to determine a combined proximity result for two transceivers, the mobile device comprising: at least two modules for determining results for at least two types of proximity, respectively, the at least two modules from a group comprising: a geographic proximity module to determine a geographic proximity; a radio proximity module to determine a radio proximity; and a cellular proximity module to determine a cellular proximity; and a logical combiner coupled to each of the at least two modules, wherein the logical combiner logically combines proximity results to determine the combined proximity result.

According to some aspects, disclosed is a mobile device to determine a combined proximity result for two transceivers, the mobile device comprising: means for determining results for at least two types of proximity, from of a group comprising: geographic proximity; radio proximity; and cellular proximity; and means for logically combining proximity results to determine the combined proximity result.

According to some aspects, disclosed is a non-transient computer-readable storage medium including program code stored thereon to determine a combined proximity result for two transceivers, comprising program code to: determine results for at least two types of proximity from a group comprising: geographic proximity; radio proximity; and cellular proximity; logically combine the results for the at least two types of proximity to form the combined proximity result.

According to some aspects, disclosed is a method to determine proximity of two transceivers, the method comprising: determining a coarse proximity result; determining a fine proximity result based on the coarse proximity result being proximate; and determining a combined proximity based on the fine proximity result.

According to some aspects, disclosed is a mobile device to determine proximity of two transceivers, the mobile device comprising: a transceiver; a processor coupled to the transceiver, wherein the processor contains code to: determine, by a coarse proximity test, a coarse proximity result; determine, by a fine proximity test, a fine proximity result based on the coarse proximity result being proximate; and determine a combined proximity result based on the fine proximity result.

According to some aspects, disclosed is a device to determine proximity of two transceivers, the device comprising: means for determining a coarse proximity result; means for determining a fine proximity result based on the coarse proximity result being proximate; and means for determining a combined proximity result based on the fine proximity result.

According to some aspects, disclosed is a non-transient computer-readable storage medium including program code stored thereon to determine proximity of two transceivers, comprising program code to: determine a coarse proximity result; determine a fine proximity result based on the coarse proximity result being proximate; and determine a combined proximity result based on the fine proximity result.

According to some aspects, disclosed is a method to determine proximity of two transceivers, the method comprising: determining a first proximity between a first transceiver and a second transceiver; determining second proximity between the second transceiver and a third transceiver; determining a third proximity between the first transceiver and the third transceiver based on the first proximity and the second proximity.

According to some aspects, disclosed is a mobile device to determine proximity of two transceivers, the mobile device comprising: logic for determining a first proximity between a first transceiver and a second transceiver; logic for determining second proximity between the second transceiver and a third transceiver; logic for determining a third proximity between the first transceiver and the third transceiver based on the first proximity and the second proximity.

According to some aspects, disclosed is a mobile device to determine proximity of two transceivers, the mobile device comprising: means for determining a first proximity between a first transceiver and a second transceiver; means for determining second proximity between the second transceiver and a third transceiver; means for determining a third proximity between the first transceiver and the third transceiver based on the first proximity and the second proximity.

According to some aspects, disclosed is a non-transient computer-readable storage medium including program code stored thereon to determine proximity of two transceivers, comprising program code to: determine a first proximity between a first transceiver and a second transceiver; determine second proximity between the second transceiver and a third transceiver; determine a third proximity between the first transceiver and the third transceiver based on the first proximity and the second proximity.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIGS. 1, 2A-B, 3 and 4 illustrate proximities, in accordance with some embodiments of the present invention.

FIGS. 5A and 5B show methods to determine proximity of two transceivers, in accordance with some embodiments of the present invention.

FIGS. 6, 7 and 8 illustrate a coarse proximity test followed by a fine proximity test, in accordance with some embodiments of the present invention.

FIGS. 9A and 9B show methods to determine proximity of two transceivers, in accordance with some embodiments of the present invention.

FIGS. 10, 11, 12 and 13 illustrate finding indirect proximity based on an intermediary transceiver, in accordance with some embodiments of the present invention.

FIGS. 14 and 15 show methods to determine proximity of two transceivers, in accordance with some embodiments of the present invention.

FIGS. 16, 17 and 18 show various methods, in accordance with some embodiments of the present invention.

FIGS. 19, 20 and 21 show various apparatuses, in accordance with some embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

FIGS. 1, 2, 3 and 4 illustrate proximities, in accordance with some embodiments of the present invention. Proximity may be determined in several ways. In FIG. 1, three individual proximities (geographic proximity 102, radio proximity 104 and cellular proximity 106) are shown.

Geographic proximity 102 of a first transceiver from a second transceiver occurs when the transceivers are within a predetermined distance from each other. The first and second transceivers may be two mobile devices, an access point and a mobile device, or two access points. An access point is use generically to include a node-B, a WiFi access point, a cellular base station, and the like. For convenience, the first transceiver and the second transceiver are referred below each as a mobile device. As such, geographic proximity 102 between two mobile devices occurs when the mobile devices are within a predetermined distance from each other. For example, two mobile devices may satisfy geographic proximity 102 with the mobile devices are within 100 meters of each other. If more than two devices are considers, geographic proximate may be determine if the group of mobile devices is within a circle of a predetermined diameter (i.e., direct geographic proximity 102).

Three or more mobile devices may be considered indirectly proximate as well. For example, a first mobile device may have direct proximity with a second mobile device but not direct proximity with a third mobile device. When the second mobile device has direct proximity with the third mobile device, the first mobile device and third mobile device have indirect proximately.

Geographic proximate may be determine if a mobile device is within a predetermined distance of at least one other mobile device, which is in turn within the predetermined distance of at least one other mobile device, and so on (i.e., indirect geographic proximity 102). In this case, a first mobile device and third mobile device may both be within geographic proximately of an intermediary second mobile device but not within geographic proximately of each other.

Radio proximity 104 of mobile devices occurs when the mobile devices may communicate directly to each other via a radio channel. Two mobile devices may satisfy radio proximity 104 when they may communicate via an RF channel (e.g., a cellular frequency). Three or more mobile devices may be considers in direct radio proximity 104 when each mobile device in the group may directly communicate with each other mobile device in the group. Three or more mobile devices may be considers in indirect radio proximity 104 when each mobile device in the group may communicate with each other mobile device in the group via one or more mobile devices in the group.

A cellular proximity 106 may be determined if two mobile devices are serviced by the same cell. Alternatively, cellular proximity 106 may be determined if two mobile devices have coverage of the same cell. Alternatively, two mobile devices may be considered to have cellular proximity 106 when the two mobile devices are serviced (or have coverage) by neighboring cells. Three or more mobile devices may have direct cellular proximity 106 when all mobile devices: (1) are services by the same cell; (2) have coverage of the same cell; (3) are services by neighboring cells; or (4) have coverage of neighboring cells. Three or more mobile devices may have indirect cellular proximity 106 when each mobile device has direct proximity with some other mobile device in the group.

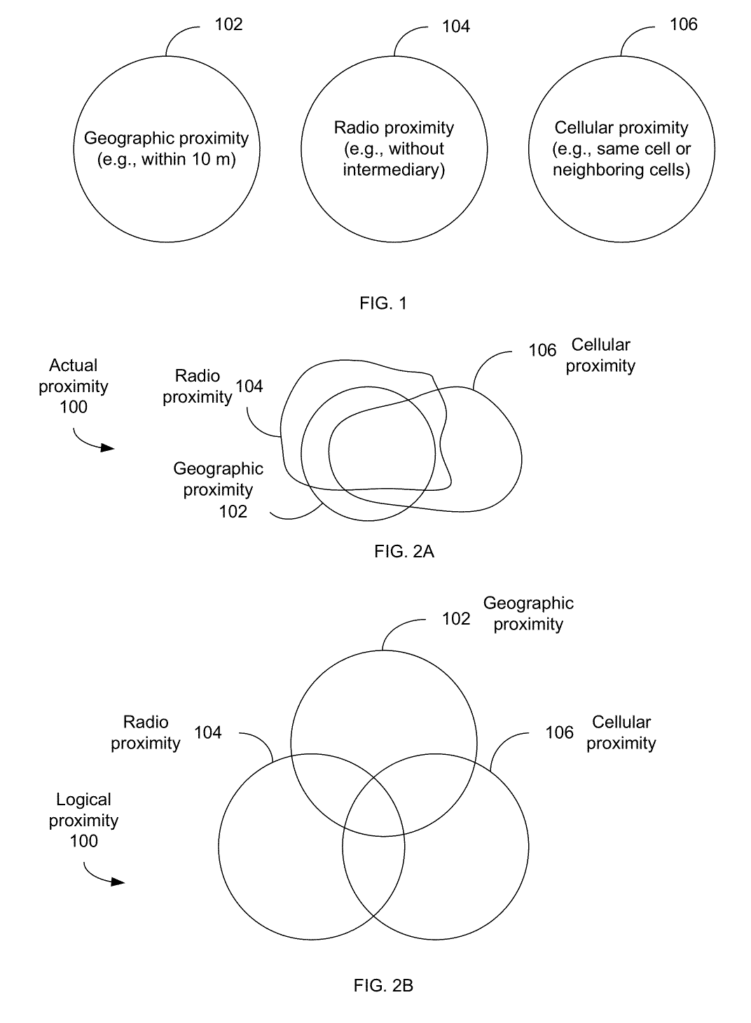

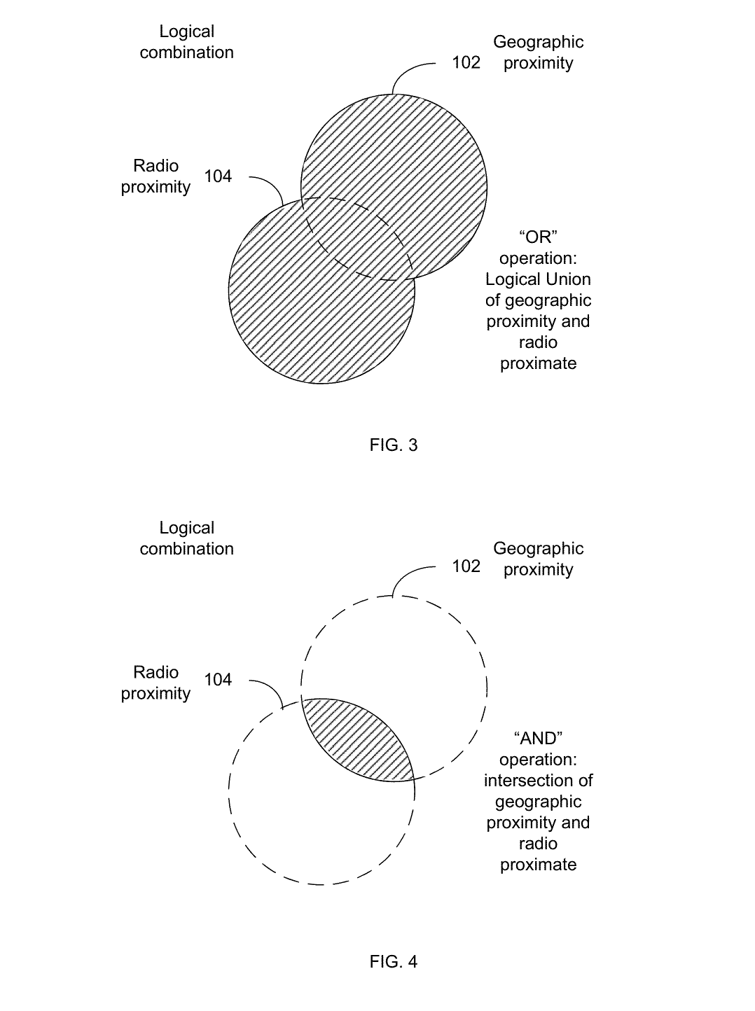

FIG. 2A shows a Venn diagram of an example of actual proximity shapes. For simplicity though a logical simplification of proximity shapes are illustrated in FIG. 2B. A Venn diagram is shown to contain intersecting proximities. Two transceivers may be found to have geographic proximity 102 and/or radio proximity 104 and/or cellular proximity 106. For example, two transceivers may have geographic proximity 102 but not radio proximity 104 or cellular proximity 106. The two transceivers may both be mobile devices. Alternatively, one transceiver may be a mobile device and the other transceiver may be an access point. In the following example, two transceivers are defined as creating proximate. In other examples, three or more transceivers are defined as creating proximate. In other examples, a set of M (M≧3) transceivers is defined where proximity is determined when at least N (N≧2 and M≧N) transceivers are proximate. Parameters N and M are predetermined. For example, when at least N=3 friends from a group of M=10 friends are proximate, the proximate friends are notified.

The proximity methods may be logically combined with logical AND and OR operations. For example with a first definition of proximity, two mobile devices are determined to be proximate when they are both have geographic proximity 102 and radio proximate 104. Alternatively with a second definition of proximity, two mobile devices are determined to be proximate when they are have either geographic proximity 102 or radio proximate 104. A more complex logical operation may be set up as well. For example with a third definition of proximity, two mobile devices are determined to be proximate when they have both geographic proximity 102 and radio proximate 104 or they are in cellular proximately 106.

The definition for proximity may be setup as a logical combination of two, three or more individual test for proximity. Rules may also require three mobile devices to satisfy a determination of proximately. For example, three mobile devices are determined to be proximate when they are all within geographic proximity 102 and a cellular proximately 106.

In FIG. 3, a test for proximity is defined as a logical “OR” of geographic proximity 102 and radio proximity 104. The logical “OR” operation is a logical union of results from a geographic proximity test and a radio proximity test. In this example, proximity requires either geographic proximity 102 “OR” radio proximity 104. That is, proximity is found if either geographic proximity 102 or radio proximity 104 are found.

In FIG. 4, a test for proximity is defined as a logical “AND” of geographic proximity 102 and radio proximity 104. The logical “AND” operation is a logical intersection of results from a geographic proximity test and a radio proximity test. In this example, proximity requires both geographic proximity 102 “AND” radio proximity 104. That is, proximity is found if both geographic proximity 102 and radio proximity 104 are found.

A discovery process may use an intersection of proximity types to facilitate finding proximate mobile devices. That is, a certain proximity type may be more efficiently found be starting with a list of candidate mobile devices of one proximity type and determining which of those candidate mobile devices are also of the certain proximity then performing a more exhaustive search with a much shorter list. For example, consider a set S_{R} of mobile devices having radio proximity 104 to a particular target mobile device. In this case, assume radio proximity 104 is more efficiently determined than geographic proximity 102. That is, the ability for two devices to communicate via radio signals may be determined more quickly or easily than determining a geographic location of each device and a distance between the devices. In some embodiments, the set S_{R} may be a list of mobile devices that also meet a certain expression with the target mobile device. Alternatively, the set S_{R} may be a list of mobile devices regardless of similarity with the target mobile device.

An efficient discovery process to determine mobile devices having geographic proximity 102 may follow a three-step process assuming a set S_{R} of mobile devices having radio proximity 104 to a target mobile device is known. First, determine a subset S_{G} of mobile devices within set S_{R}, which may be expressed as an intersection of the set S_{R} with the subset S_{G} {(S_{R}∪S_{G})}. Second, search for other mobile devices not within set S_{R} but still within geographic proximity 102 of the target mobile device, which may be expressed as {( S̅_{R}∪S_{G})}. Third, combine the intersecting subsets together. Such a process may be expressed as a union of step one and step two {(S_{R}∪S_{G})∪( S̅_{R}∪S_{G})}. In the first step, because radio proximity 104 is easier and more efficient to determine than geographic proximity 102, a list of candidate geographic proximate mobile devices may be approximated by those mobile devices that have radio proximity 104. The first step allows for a quick culled down list of candidate mobile devices with a greater likelihood of also having geographic proximity 102. In the second step, a more exhaustive and time consuming process of determining a location of mobile devices, and thus a geographic distance, may be limited to mobile devices that still may be geographic proximate but do not have radio proximity 104. A prior art method just searches for geographic proximity 102 (in step two) without regarding radio proximity 104.

An efficient discovery process to determine mobile devices having cellular proximity 106 may follow a three-step process assuming a set S_{R} of mobile devices having radio proximity 104 to a target mobile device is known. First, determine a subset S_{C} of mobile devices within set S_{R}, which may be expressed as {(S_{R} ∪S_{C})}. Second, search for other mobile devices not within set S_{R} but still within cellular proximity 106 of the target mobile device, which may be expressed as {( S̅_{R} ∪S_{C})}. Third, combine the intersecting subsets together. Such a process may be expressed as {(S_{R} ∪S_{C})∪( S̅_{R} ∪S_{C})}. In the first step, because radio proximity 104 may be easier and more efficient to determine than cellular proximity 106, a list of candidate cellular proximate mobile devices may be approximated by those mobile devices that are radio proximate 104. The first step allows for a quick culled down list of candidate mobile devices with a greater likelihood of being cellular proximity 106. In the second step, a more exhaustive process of determining cellular proximity 106 may be limited to mobile devices that still may have cellular proximately 106 but not radio proximity 104. A prior art method just searches for cellular proximity 106 (in step two) without regards to any radio proximity 104.

Assume a set S_{C} of mobile devices having cellular proximity 106 with a target mobile device is known (e.g., all mobile devices being served by the same cell). An efficient discovery process to determine mobile devices having radio proximity 104 may follow a three-step process. First, determine a subset S_{R} of mobile devices within set S_{C}, which may be expressed as {(S_{C} ∪S_{R})}. Second, search for other mobile devices not within set S_{C} but still within radio proximity 104 of the target mobile device, which may be expressed as {( S̅_{R} ∪S_{C})}. Third, combine the intersecting subsets together. Such a process may be expressed as {(S_{C} ∪S_{R})∪( S̅_{C} ∪S_{R})}. In the first step, because cellular proximity 106 may be easier and more efficient to determine than radio proximity 104, a list of candidate radio proximate mobile devices may be approximated by those mobile devices that are cellular proximate 106. The first step allows for a quick culled down list of candidate mobile devices with greater likelihood of being radio proximity 104. In the second step, a more exhaustive process of determining radio proximity 104 may be limited to mobile devices that still may have radio proximity 104 but not cellular proximate 106.

In this manner, instead of performing a fine grained method for determining a certain proximity for all mobile devices near a target mobile device, a coarse grained method (step one) is used on a first group of mobile devices then a fine grained method (step two) is used on a second group of mobile devices. In some embodiments, a coarse method quickly reduces the candidate pool or a superset of mobile devices and the fine method determines proximity for a second set of additional mobile devices whose proximity is unsure. In other embodiments, the coarse method acts as a first pass to narrow a superset and the fine method acts as a final pass to further narrow the superset. Often a coarse grain method is efficient and fast but a fine method is slower but more accurate. In many cases, the coarse method is over inclusive. In these cases, if the coarse method finds no mobile devices, then time and processing power may be saved by not performing a fine method.

The coarse method determines an initial approximation and the fine method finds a final determination. The coarse method is used to more efficiently determine a candidate superset, which may then be refined by the fine method. For example, a method to determine what mobile devices are within radio proximity 104 may include first developing a superset of mobile devices belonging to either a current serving cell or N neighboring cells, where N includes cells forming a number of rings of cells round the serving cell. The superset may be formed iteratively by forming a list of candidate mobile devices comprising mobile devices having a certain proximity to other mobile devices having the certain proximity to a target mobile device. For example, the superset may include all mobile devices having radio proximity 104 with any mobile device having radio proximity 104 to a target mobile device. Alternatively, the superset may include all mobile devices having geographic proximity 102 to any mobile device having geographic proximity 102 to a target mobile device. The superset may include all mobile devices having a cellular proximity 106 to any mobile device having cellular proximity 106 to a target mobile device.

Often the fine method is not very efficient therefore the coarse method on a first set of mobile devices occurs first followed by the fine method occurring on smaller set of mobile devices second. The fine method may include a round-trip time (RTT) method, location method, an observed time difference (OTD) method, a combination of two or more of these methods, or the like. Generally, an RTT method is very accurate but has average efficiency. A location method is also very accurate but has low efficiency. An OTD method has average accuracy and average efficiency. The coarse methods may also include a radio method, a cellular method, an iterative method, and the like. A radio method has average accuracy but high efficiency. A cellular method has low accurate but high efficiency. An iterative method also has low accurate but high efficiency. A mobile device may perform an RTT method, a location method, an OTD method and a radio method. A network may perform a location method, a cellular method and an iterative method.

Typically, an RTT method uses measurements between two mobile devices. This RTT method though may be iterative by obtaining RTT measurements between a mobile device and a subset of nearby mobile devices. Therefore, it is possible to determine an RTT distance between two mobile devices without a direct connection between the two mobile devices. First, distances among a network or subset of mobile devices are determined. Second, a distance is determined between a target mobile device and one or more mobile devices in the network of mobile devices.

In the simplest case, a network is formed by two mobile devices (device A and device B). A distance is determined between the two mobile devices (e.g., D_{AB}). A target mobile device has direct radio communications with one but not the other of the two mobile devices forming the network. In this example case, assume the target mobile device only has radio contact with device A and not device B. The distance (e.g., D_{TA}) from the target mobile device and device A and the distance (e.g., D_{AB}) from device A and device B are known. Therefore, the distance (e.g., D_{TB}) from the target mobile device to device B may be approximated as: (1) the sum of the two distances (e.g., D_{TB}=D_{TA}+D_{AB}); (2) a fraction of the sum of the two distances (e.g., D_{TB} (D_{TA}+D_{AB})/\sqrt{2}); or (3) the sum of one distance and a fraction of the second distance (e.g., D_{TB}=D_{TA}+D_{AB}/\sqrt{2}).

In general, a network of mobile devices may create a “rigid structure” with three or more mobile devices. A target mobile device having contact with two or more mobile devices in the rigid structure may determine a location on a plane of the target mobile device. Using this RTT method, geographic distance between to mobile devices (even without radio proximity) may be computed.

A location method may be used as a fine method. A location method determines and compares two or more absolute mobile device position estimates. Known uncertainties in a position estimate of a mobile device with produce a corresponding uncertainty (or error) in a distance estimate derived from the uncertain position estimate. Some mobile devices determine their position estimates continuously without significant battery drain. Motion sensors may be used to disable continuous position estimation with a mobile device is stationary and enable continuous position estimation with the mobile device is moving. A position estimate may also be determined by known cellular or WiFi based means.

Embodiments disclosed herein may distinguish between two types of proximity or among three or more types of proximity. For example, some systems may consider only radio proximity 104 and geographic proximity 102 while other systems may consider only radio proximity 104 and cellular proximity 106. Each proximity may be parameterized (e.g., via a maximum distance for which proximity discovery is allowed). Different proximity types may share these parameters or each proximity type may have its own parameter. Parameters may differ between two networks, two services and/or two mobile devices.

In some embodiments, a table of mobile devices is maintained for one proximity type for each target mobile device. For example, a table lists all mobile devices meeting radio proximity 104 to a target mobile device. In some embodiments, a table of mobile devices is maintained having a logical combination of two or more proximity types. For example, for a certain target mobile device, a table lists all mobile devices meeting radio proximity 104 and geographic proximity 102 to the target mobile device.

A proximity may be defined on a system wide level or for each mobile device. For example, geographic proximity 102 may be defined as 1000 meters for all mobile devices. Alternatively, geographic proximity 102 may be defined as 300 meters for a first mobile device, 1000 meters for a second mobile device, and 2000 meters for a third mobile device. Alternatively, a service or application within a certain mobile device may determine a proximity definition. For example, a certain mobile device may determine geographic proximity 102 as 300 meters for a first application, 1000 meters for a second application, and 2000 meters for a third application within the certain mobile device

Proximity definitions may include one or more performance parameters or relationships. For example, radio proximity 104 may require the ability to perform direct two-way radio communication. Alternatively, radio proximity 104 may only require one-way radio communication. Radio proximity 104 may require a minimum signal level, signal strength, and/or signal quality. Radio proximity 104 may require a minimum bandwidth between the transceivers.

For geographic proximity 102, a system may be limited to a maximum distance between two mobile devices (e.g., 1 mile), a state of motion of or between two mobile devices (e.g., both relatively stationary, or both driving the same direction and speed), and/or at an absolute general location (e.g., both mobile devices at the mall, on campus, in the same store or in a library).

For cellular proximity 106, a parameter may indicate if cellular proximity 106 is limited to mobile devices being served by a common eNodeB or other cell. Alternatively, the parameter may indicate if cellular proximity 106 is broadly defined to mobile devices able to detect or in a common coverage area in a common cell.

Some parameters may be common among proximity types. For example, a minimum length of time T must persist before discovery of a new proximity is confirmed (e.g., geographic proximity 102 must persist for 5 seconds before a transition from non-geographic to geographic proximity 102 is determined). As another example, a parameter may indicate whether a network attachment status for one or both mobile devices is necessary (e.g., whether both mobile devices must be attached to a common network).

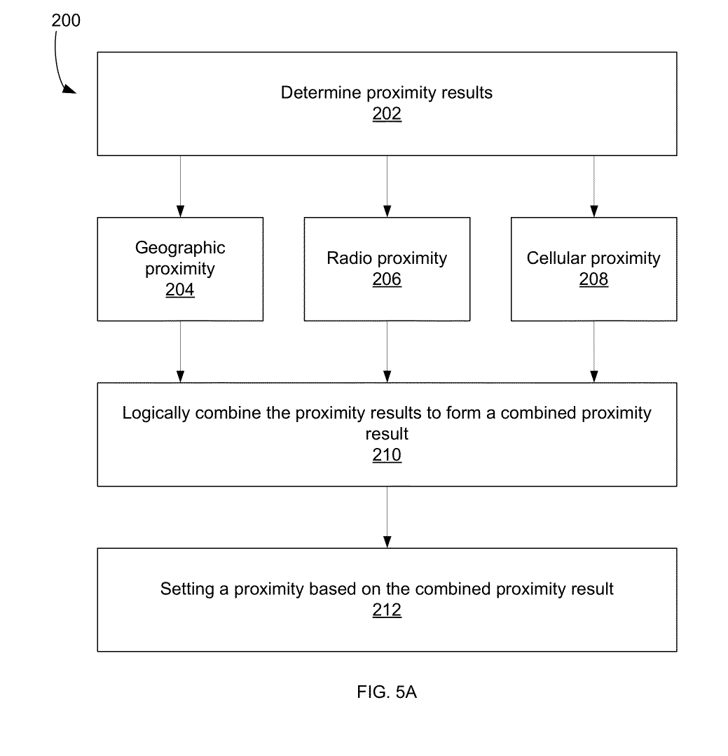

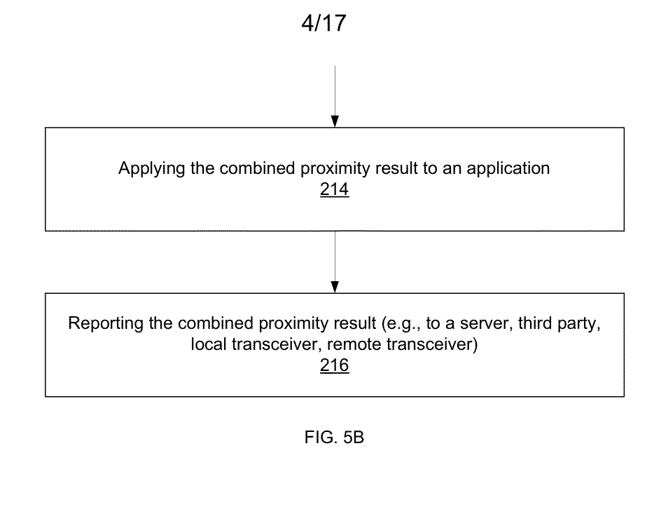

FIGS. 5A and 5B show methods to determine proximity of two transceivers, in accordance with some embodiments of the present invention. FIG. 5A shows a method 200 to determine proximity of two transceivers, in accordance with some embodiments of the present invention. At 202, a processor makes a determination of proximate results of two or more proximate tests. For example, at 204, geographic proximity 102 is determined. At 206, radio proximity 104 is determined. At 208, cellular proximity 106 is determined.

At 210, the processor logically combines the proximate results from two or more proximate test to form a combined proximity result. In some embodiments, the processor may use one proximity to determine another proximity. That is, a first proximity may be used as a short cut to find a second proximity. For example, mobile devices in radio proximity 104 may be examined first to determine geographic proximity 102. Therefore, at a first step, the intersection between radio proximity 104 and geographic proximity 102 becomes a first indication of mobile devices in geographic proximity 102. At a second step, just those remaining mobile devices that are not in radio proximity 104 but could be in geographic proximity 102 are tested with more exhaustive testing. At 212, the processor sets an overall proximity based on the combined proximity result.

FIG. 5B continues FIG. 5A with optional step. At 214, the processor optionally applies the combined proximity result to an application. For example, the application may be a friend finder application to find friends when they are nearby. At 216, the processor optionally reports the combined proximity result, for example, to a server, a third party such as a police agency, the user of the first transceiver, a user of the second transceiver.

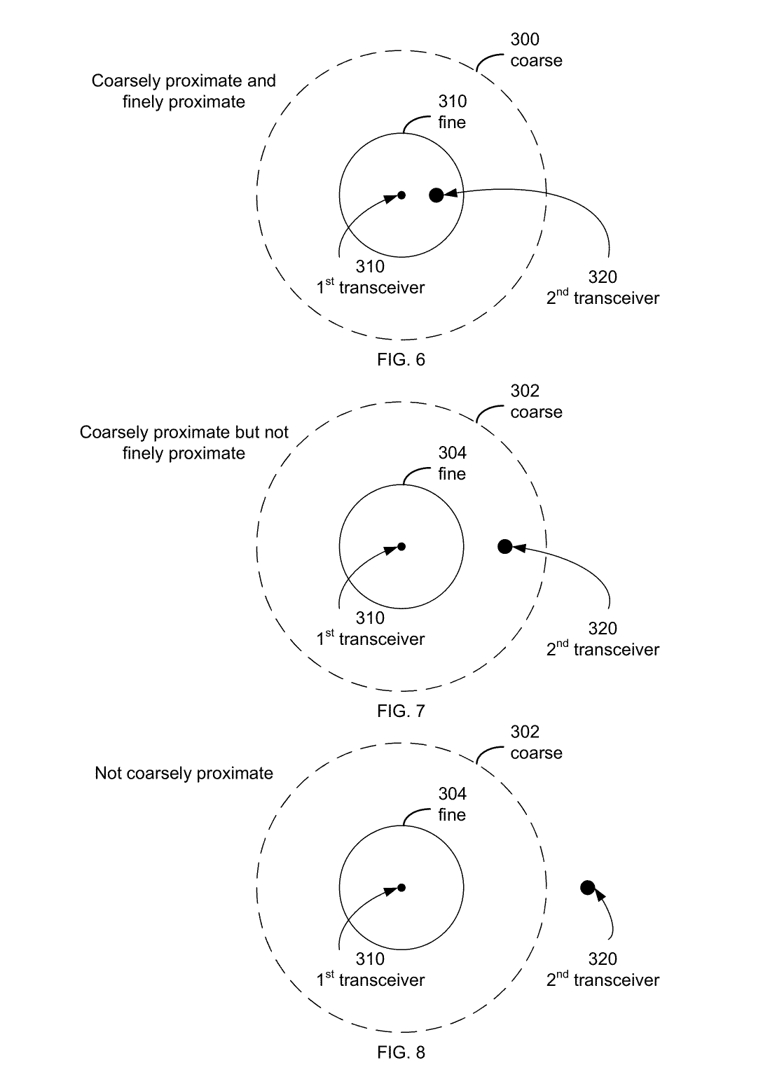

FIGS. 6, 7 and 8 illustrate a coarse proximity test followed by a fine proximity test, in accordance with some embodiments of the present invention. In FIG. 6, two transceivers are both coarsely proximate and finely proximate. A coarse proximity test at the first transceiver determines that a second transceiver is coarsely proximate. A fine proximity test at the first transceiver determines that the second transceiver is also finely proximate. The coarse proximity test is faster and takes less processing power than the fine proximity test. Often proximate may be ruled out based solely on the coarse proximity test. In this manner, only questionable transceivers are tested with the fine proximity test.

In FIG. 7, two transceivers are coarsely proximate but not finely proximate. A coarse proximity test at the first transceiver determines that a second transceiver is coarsely proximate. However, a fine proximity test at the first transceiver determines that the second transceiver is not finely proximate.

In FIG. 8, two transceivers are not coarsely proximate. A coarse proximity test at the first transceiver determines that a second transceiver is not coarsely proximate. In this case, processing power is not expended running a fine proximity test because the transceivers are not coarsely proximate.

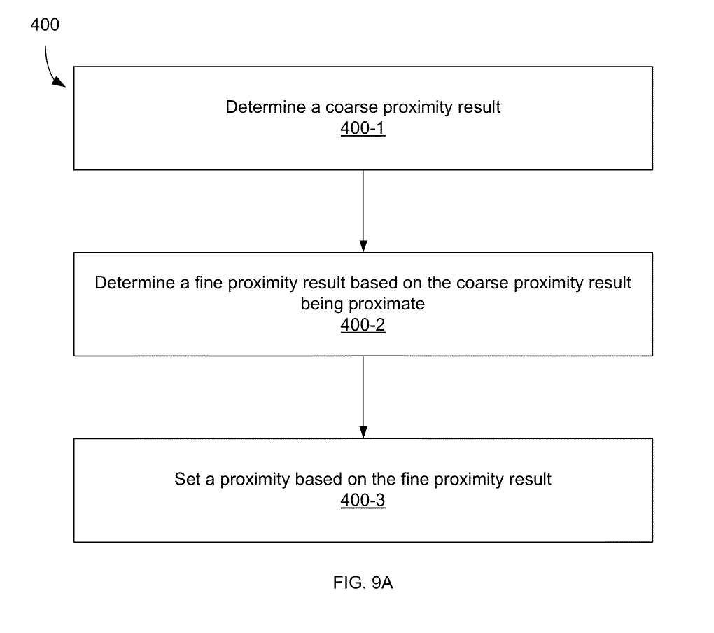

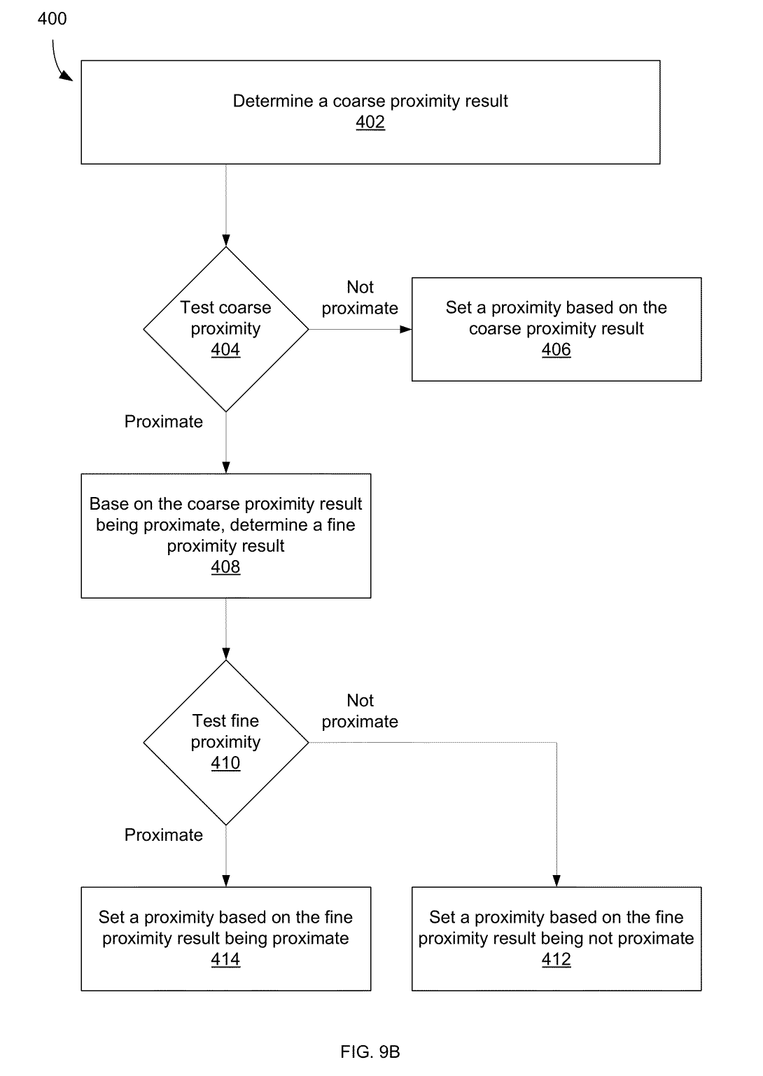

FIGS. 9A and 9B show methods 400 to determine proximity of two transceivers, in accordance with some embodiments of the present invention. In FIG. 9A a method 400 to determine proximity of two transceivers is shown. At 400-1, a processor determines a coarse proximity result. At 400-2, the processor determines a fine proximity result based on the coarse proximity result being proximate. At 400-3, the processor sets a proximity based on the fine proximity result.

FIG. 9B shows another method 400 to determine proximity of two transceivers. At 402, a processor determines a coarse proximity result. The coarse proximity test may definity determine if two transceivers cannot be proximate but is indefinite about whether the two transceivers are proximate. At 404, the processor branches to 406 if the coarse proximity result is not proximate and 408 if the coarse proximity result is proximate. At 406, the processor sets a proximity based on the coarse proximity result being not proximate. At 408, the processor determines a fine proximity result. At 410, the processor branches to 412 if the fine proximity result is not proximate and 414 if the fine proximity result is proximate. At 412, the processor sets the proximity based on the fine proximity result being not proximate. At 414, the processor sets the proximity based on the fine proximity result being proximate.

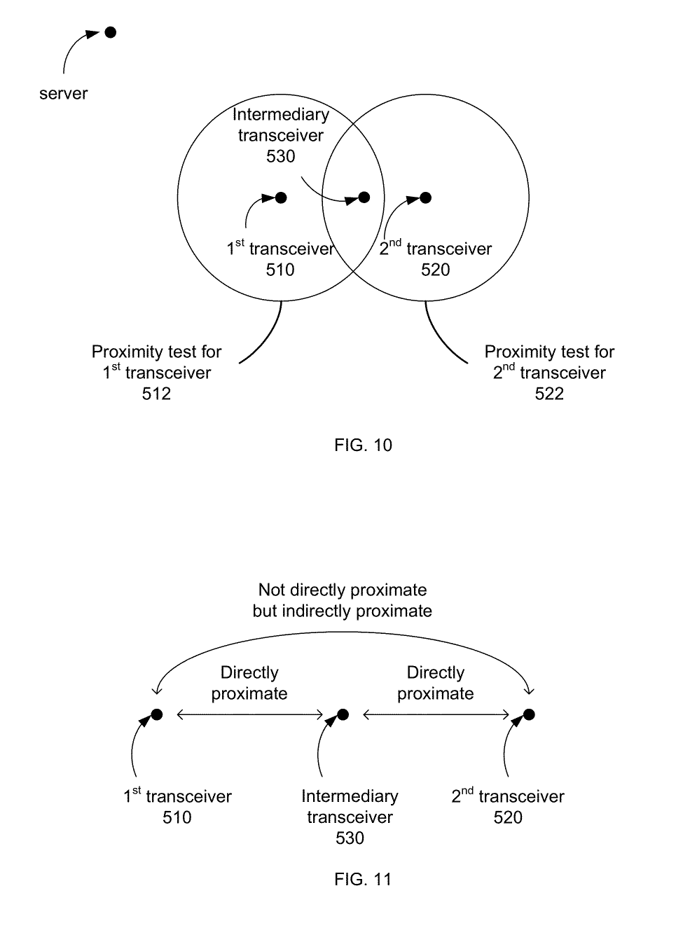

FIGS. 10, 11, 12 and 13 illustrate finding indirect proximity based on an intermediary transceiver, in accordance with some embodiments of the present invention. In FIG. 10, a first transceiver 510, a second transceiver 520 and a server are shown. The first transceiver 510 and the second transceiver 520 are not directly proximate. That is, the first transceiver 510 and the second transceiver 520 do not pass a proximate test. A third transceiver (shown as intermediary transceiver 530) is directly proximate to both the first transceiver 510 and the second transceiver 520. That is, a proximate test 512 at the first transceiver 510 shows that the intermediary transceiver 530 is proximate to the first transceiver 510, and a proximate test 522 at the second transceiver 520 also shows that the intermediary transceiver 530 is proximate to the second transceiver 520. The proximate tests 512 and 522 may be the equivalent proximity test. Any or all of the transceivers may send and report to the server (e.g., a network proximity server) proximity information or proximity data.

In FIG. 11, the first transceiver 510 is shown not directly proximate to the second transceiver 520. The first transceiver 510 is directly proximate to the intermediary transceiver 530. The second transceiver 520 is also directly proximate to the intermediary transceiver 530. As a result, the first transceiver 510 is indirectly proximate to the second transceiver 520.

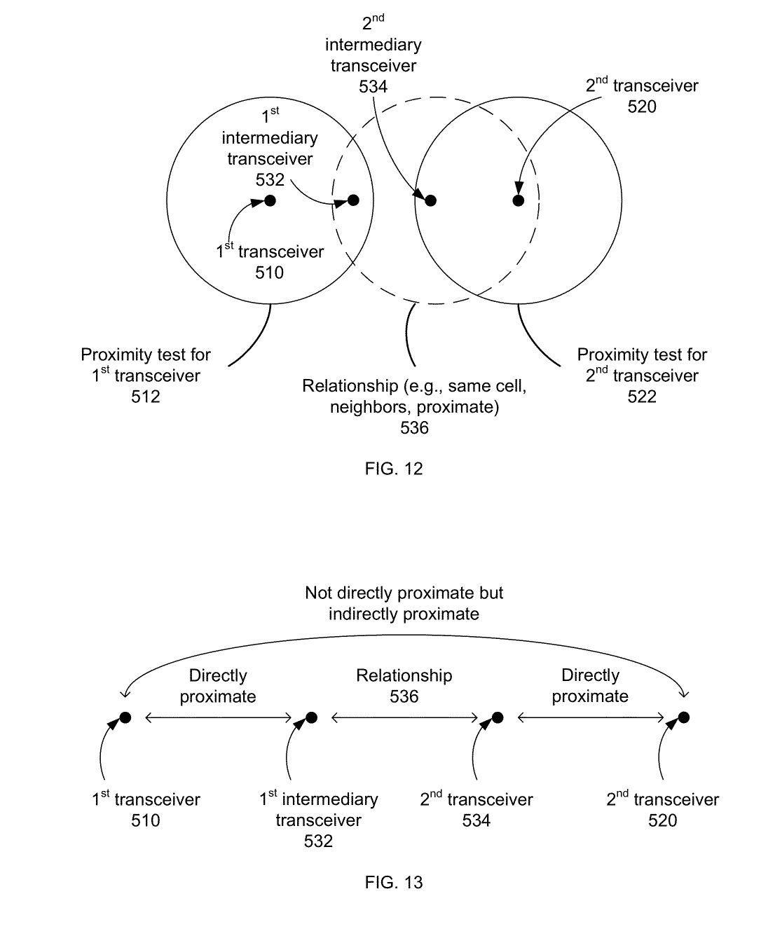

In FIG. 12, a first transceiver 510 and a second transceiver 520 are shown. Again, the first transceiver 510 and the second transceiver 520 are not directly proximate. A third and fourth transceivers (shown as a first intermediary transceiver 532 and a second intermediary transceiver 534) are respectively directly proximate to the first transceiver 510 and the second transceiver 520. That is, a proximate test 512 at the first transceiver 510 shows that the first intermediary transceiver 532 is proximate to the first transceiver 510, and a proximate test 522 at the second transceiver 520 also shows that the second intermediary transceiver 534 is proximate to the second transceiver 520. The first intermediary transceiver 532 and the second intermediary transceiver 534 relate to one another by a relationship 536. The relationship may be that they are both services by the same cell, both have coverage of the same cell, are services by neighboring cells, have coverage of neighboring cells, or pass a proximity test themselves.

In FIG. 13, the first transceiver 510 is shown not directly proximate to the second transceiver 520. The first transceiver 510 is directly proximate to the first intermediary transceiver 532. Similarly, the second transceiver 520 is directly proximate to the second intermediary transceiver 534. The first intermediary transceiver 532 and the second intermediary transceiver 534 are related by a relationship 536. As a result, the first transceiver 510 is indirectly proximate to the second transceiver 520.

The first intermediary transceiver 532 and the second intermediary transceiver 534 may be extended to a third or more intermediary transceivers. As long each pair of intermediary transceivers in the chain of intermediary transceivers pass a proximity test, the first intermediary transceiver and the last intermediary transceiver pass a relationship 536.

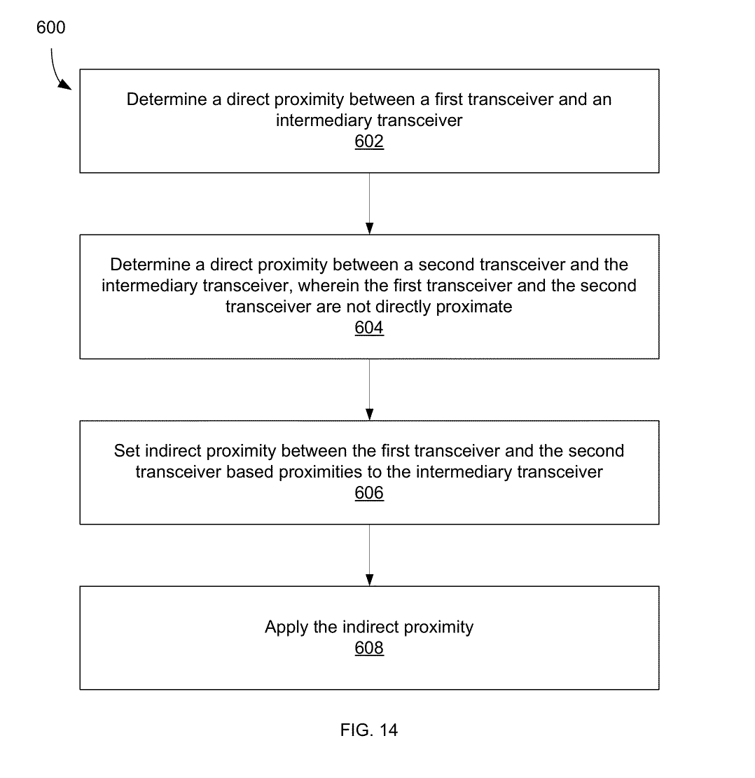

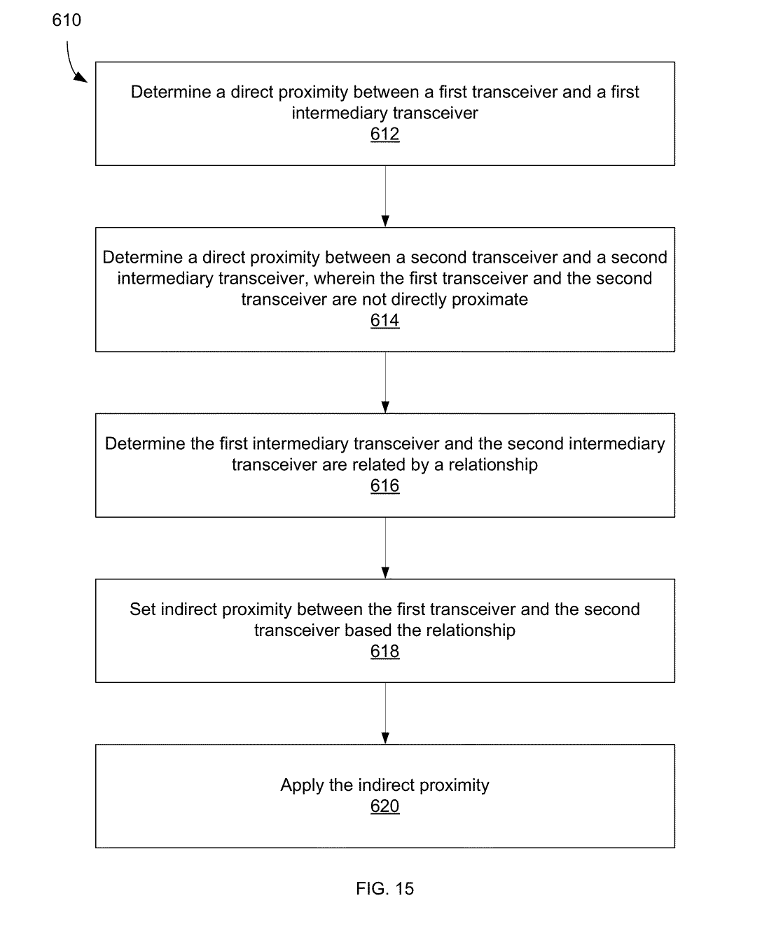

FIGS. 14 and 15 show methods 600 and 610 to determine proximity of two transceivers, in accordance with some embodiments of the present invention.

In FIG. 14, a method 600 begins at 602 with a processor determining a direct proximity between a first transceiver 510 and an intermediary transceiver 530. At 604, the processor determines a direct proximity between a second transceiver 520 and the intermediary transceiver 530. The first transceiver 510 and the second transceiver 520 are not directly proximate. At 606, the processor sets indirect proximity between the first transceiver 510 and the second transceiver 520 based proximities to the intermediary transceiver 530. At 608, the processor optionally applies the indirect proximity to an application to report or use the indirect proximity. For example, a local or remote application is invoked or the proximity is reported to a third party.

In FIG. 15, a method 610 begins at 612 with a processor determining a direct proximity between a first transceiver 510 and a first intermediary transceiver 532. At 614, the processor determines a direct proximity between a second transceiver 520 and a second intermediary transceiver 534. Again, the first transceiver 510 and the second transceiver 520 are not directly proximate. At 616, the processor determines the first intermediary transceiver 532 and the second intermediary transceiver 534 are related by a relationship 536. At 618, the processor sets indirect proximity between the first transceiver 510 and the second transceiver 520 based on the relationship 536. At 620, the processor optionally applies the indirect proximity to an application to report or use the indirect proximity.

Once proximity is found between the first transceiver 510 and the second transceiver 520, one or both of the first transceiver 510 and the second transceiver 520 may be notified. Alternately, a third party, such as parole officer monitoring the first transceiver 510 and the second transceiver 520 on ex-spouses, may be notified. A server may be notified. An application on one or both of the first transceiver 510 and the second transceiver 520 may be invoked.

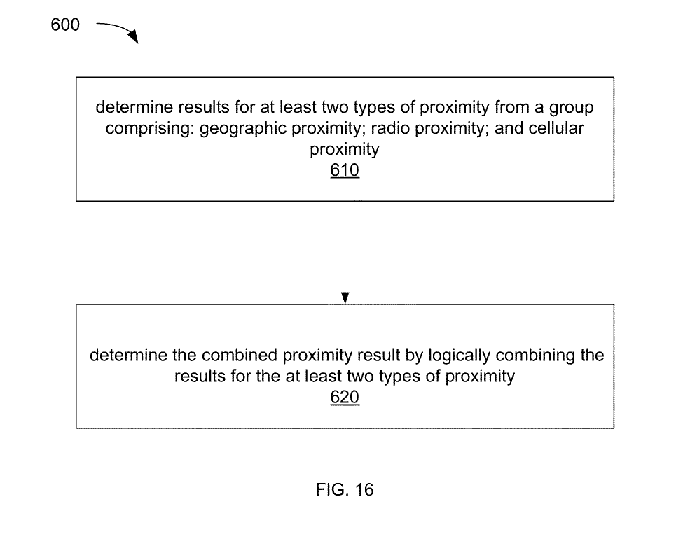

FIGS. 16, 17 and 18 show various methods, in accordance with some embodiments of the present invention.

In FIG. 16, a method 600 execute on a mobile device. The method 600 determines a combined proximity result for two transceivers. At 610, a processor determines results for at least two types of proximity from a group comprising: (1) geographic proximity; (2) radio proximity; and (3) cellular proximity. At 620, the processor determines the combined proximity result by logically combining the results for the at least two types of proximity.

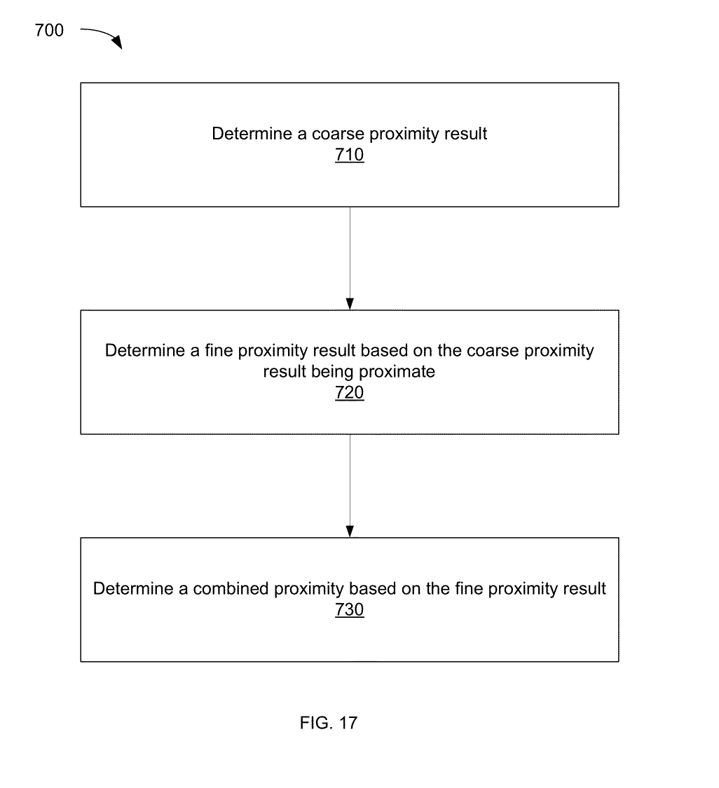

In FIG. 17, a method 700 determines proximity of two transceivers. At 710, a processor determines a coarse proximity result. At 720, the processor determines a fine proximity result based on the coarse proximity result being proximate. At 730, the processor determines a combined proximity based on the fine proximity result.

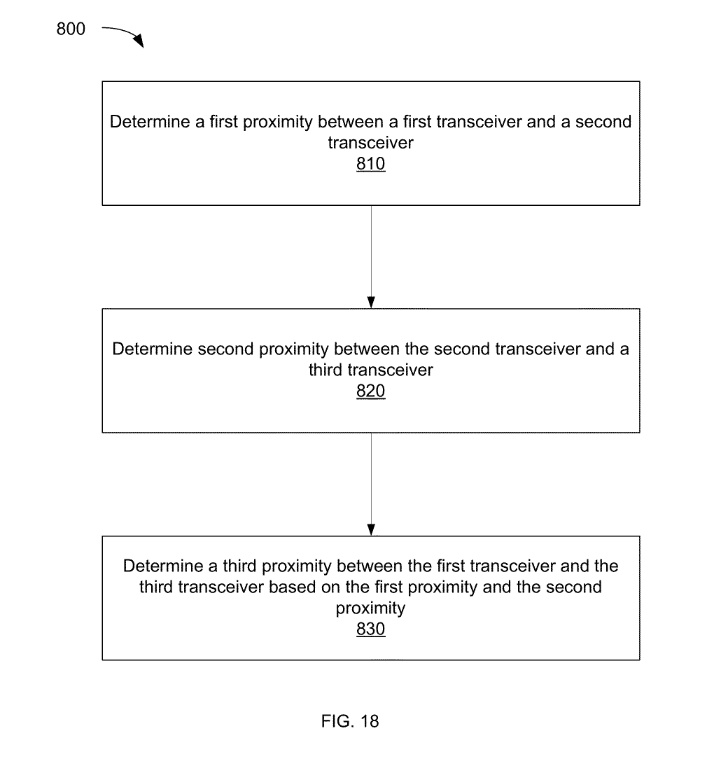

In FIG. 18, a method 800 determines proximity of two transceivers. At 810, a processor determines a first proximity between a first transceiver and a second transceiver. At 820, the processor determines second proximity between the second transceiver and a third transceiver. At 830, the processor determines a third proximity between the first transceiver and the third transceiver based on the first proximity and the second proximity.

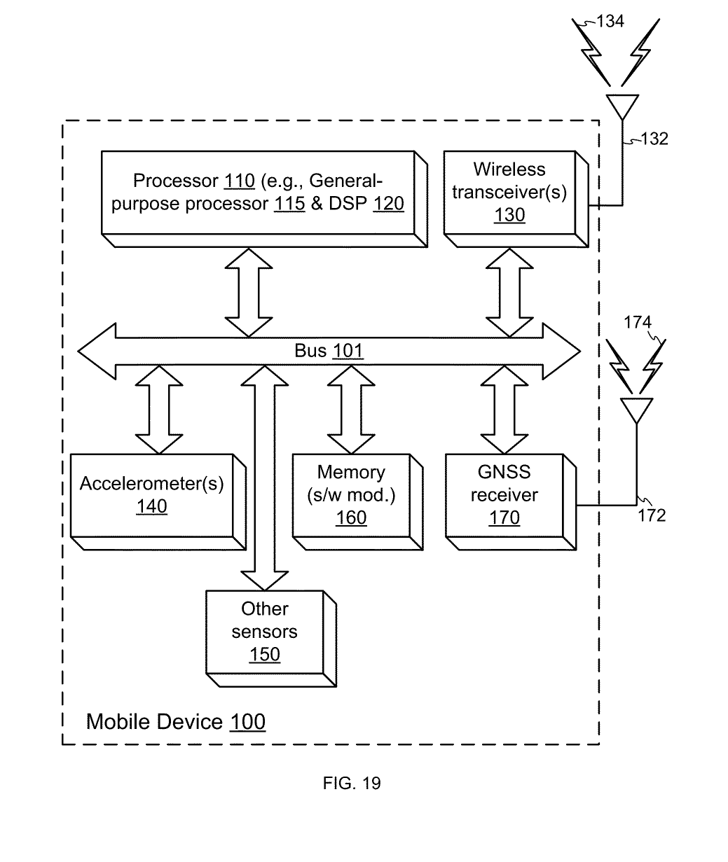

FIGS. 19, 20 and 21 show various apparatuses, in accordance with some embodiments of the present invention.

In FIG. 19, the mobile device 100 includes a processor 110 (e.g., a general-purpose processor 115 and/or a digital signal processor (DSP 120)), one or more wireless transceivers 130 electrically connected to an antenna 132 to communicate signals 134, one or more accelerometers 140, other sensors 150 (e.g., a gyrometer and/or a barometer), memory 160 and a GNSS receiver 170 electrically connected to an antenna 172 to receive signals 174. These components may be coupled together with bus 101 (as shown), directed connected together, or a combination of both. The memory 160 may contain executable code or software instructions for the processor 110 to perform methods described herein. For example, memory 160 may contain software modules to determine results for two types of proximity and logically combining the results.

Memory 160 may contain software modules to determine a coarse proximity result, to determine a fine proximity result based on the coarse proximity result being proximate, and to determine a combined proximity result based on the fine proximity result.

Memory 160 may contain software modules to determine, by a coarse proximity test, a coarse proximity result, to determine, by a fine proximity test, a fine proximity result based on the coarse proximity result being proximate, and to determine, with a logical combinder a combined proximity result based on the fine proximity result.

Memory 160 may contain software modules to determine, by a coarse proximity test, a coarse proximity result, to determine, by a fine proximity test, a fine proximity result based on the coarse proximity result being proximate, and to determine, with a logical combinder a combined proximity result based on the fine proximity result.

Memory 160 may contain software modules to determine a first proximity result between a first transceiver and a second transceiver, to determine a second proximity result between the second transceiver and a third transceiver, to determine a third proximity result between the first transceiver and the third transceiver based on the first proximity result and the second proximity result.

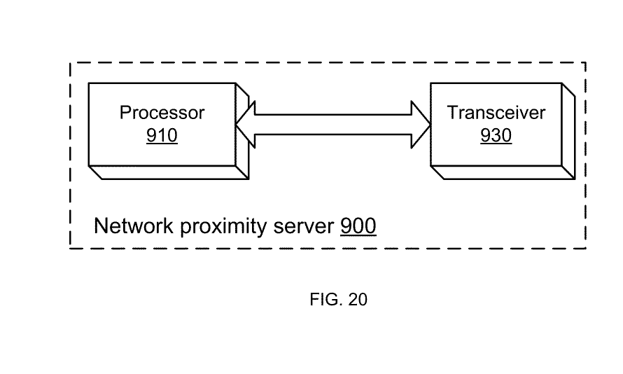

In FIG. 20, a network proximity server 900 is shown. The network proximity server 900 includes a processor 910 and a transceiver 930. The transceiver 930 is configured to receive, from the mobile device, proximity information on the mobile device and/or other nearby mobile device. The transceiver 930 is also configured to send, to the mobile device, proximity information. The processor 910 is coupled to the transceiver 930 and configured to execute functions and modules described herein for a network proximity server 900.

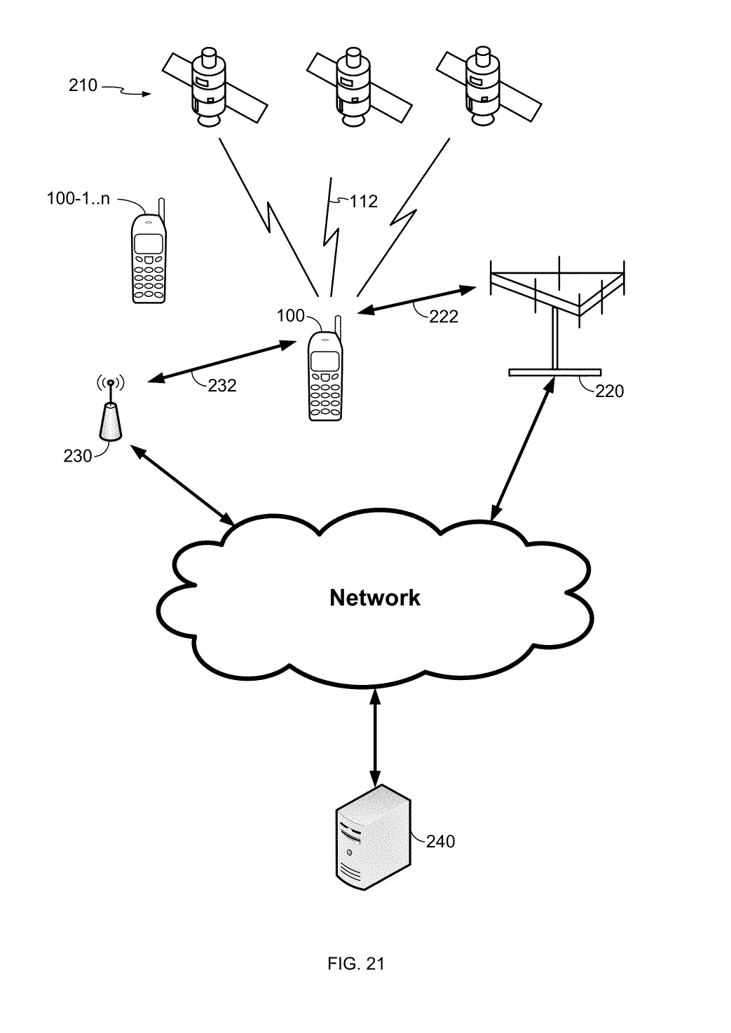

FIG. 21 shows a system including a mobile device 100, GNSS satellites 210, a macrocell 220, an access point 230, and a location server 240, in accordance with some embodiments of the present invention. The figure also shows at least one more mobile device 100-1 . . . n in proximity of the mobile device 100. The mobile device 100 receives signals 112 from GNSS satellites 210. The signals 112 may be used to compute a position fix. The mobile device 100 also communicates with the macrocell 220 using signals 222 and with the access point 230 using signals 232. In addition, the mobile device 100 may communicate with the location server 240 through a network, such as the Internet or a private network, via either the macrocell 220 or the access point 230.

Applications on the mobile device may include an application using a proximity service. A proximity service is a service available to a set of participation mobile devices that determine geographic, radio and/or cellular proximity, which triggers a provision of service. Most services may be developed by network operators, vendors, and mobile device application developers rather than standardized, for example, by 3GPP. With a symmetric service, exactly the same service is available to both devices proximate to one another. For example, two mobile devices run a two-way friend-finder application such that each device determines and alerts its proximity to the other device. With an asymmetric service, the service executes differently or is only on one device and not the other. For example, a one-way friend-finder application may execute on a first device to find all devices within a certain geographic proximity 102 (e.g., meeting a certain criterion). For asymmetric services, certain mobile devices may be restricted in features of an application while other mobile devices are unrestricted.

A group of mobile devices may be considers a proximity group. A proximity group of mobile devices has a common proximity service executing on each mobile device in the proximity group. A mobile device may be a member of one or more different proximity groups. For example, a mobile device may belong to multiple friend-finder proximity groups, each group for a different group of friends (e.g., a different group listing mobile devices of people in a common biology class, a same neighborhood, a common interest in stamp collecting, having children in a common playgroup, a common political party, or other common interest or hobby). Proximity groups may be sent up for a network operator, a certain OEM, a chip maker, an OS provider, an application provider, or a third party provider.

A proximity group may be encoded in a binary word (e.g., 128 bits long). For example, when determining radio proximity 104, only the binary word needs to be exchanged to determine if the other mobile device meets both requirements of ability to communicate directly radio to radio and also meets a certain criterion as found within the binary word. A particular proximity group may include an identifier (such as a set bit in a binary word, or a group identifier). A particular proximity group may also include certain performance parameters, which may be part of an application running on the mobile device. A mobile device's identity may be hidden by a network assigning a temporary identifier or by an encoded identifier (e.g., derived using hashing and/or ciphering from an IMSI). A true mobile device's identity may be identified only after successful authentication. For example, a shared secret key, public-private keys or a trusted server may be used to support authentication. Authentication may not be though when the main purpose of the proximity service receives but does not transmit information.

Proximity may be discovered in a variety of manners. For example, “LTE-D discovery” may employ direct mobile-to-mobile device discovery using LTE-D. LTE-D discovery may be autonomous or network controlled. Mobile devices may act as relays (e.g., forwarding broadcast received between mobile devices, for example, for public safety). Signal characteristics and RTT may be used use to determine occurrence of geographic proximity and radio proximity.

“Server discovery” may occur via a network proximity server. Parameters and data for each proximity group are provided to a network server. A mobile device may provide the current status listing other mobile devices already detected within proximity. The network server may broadcast this status information or other data to other mobile devices, such as mobile devices belonging to a common proximity group or mobile devices listed as having the same current status.

A mobile device may discover other mobile devices a broadcast (e.g., in LTE or WiFi networks). Similarly, one mobile device may broadcast its position and other mobile devices may receive the broadcast to determine proximity. To detect broadcasting mobile devices, a mobile device may interact with a network (such as through a network proximity server) by sending its own proximity data to the network. The mobile device may also sent proximity data that it has discovered about nearby mobile devices. A mobile device may receive proximity data from the network as well. For example, a network proximity server may send to the mobile device proximity data on other mobile devices in nearby region or in the same proximity group as the mobile device. In some embodiments, an application on the mobile device may enable or disable proximity detection.

A network proximity server may obtain proximity data for all mobile devices in a served area directly from the mobile devices and/or the network, such as from a MME (Mobility Management Entity) and an eNodeB. The network proximity server may be a separate entity or a new logical function in an existing entity or subsystem (e.g., in an eNodeB, MME, PDG, IMS (IP Multimedia Subsystem), SLP (SUPL Location Platform), E-SMLC (Evolved Serving Mobile Location Center)). The server may scan data it receives for mobile devices in its serving area for potential proximity matches. In some embodiments, a network proximity server may: (1) find all mobile devices belonging to a common proximity group; (2) authenticate membership claimed by a mobile device in each proximity group; (3) verify geographic, cellular or probable radio proximity conditions for the mobile devices in the same group; and (4) for each group where a set S of mobile devices are discovered to be in proximity, send data on the discovered mobile devices in the set S to some or all of the mobile devices in set S, for example, according to which mobile devices in the set S are allowed to receive this data. The server may, instead or in addition, broadcast proximity data it receives to all mobile devices. The mobile devices are then responsible for proximity detection. The data broadcast in each cell may contain data just on mobile devices in or nearby to the cell thereby reducing the amount of broadcast data.

Each mobile device (or the serving MME/eNodeB) may update data in a server periodically or when there is a change (e.g., a change serving cell of mobile device, a change in a location of a mobile device, a change of set of mobile devices detected by a mobile device, or a change of an application requirement or user definition for a proximity group). A network proximity server may remove data it has collected for a mobile device following a timeout so information does not become stale. The network proximity server may also receive proximity data (e.g., for network defined proximity groups) via O&M (Operations and Maintenance) server or from other servers.

In some embodiments, a network tells mobile devices whether or not proximity discovery is permitted. Network controls may be broadcast and/or provided at network attachment or registration. An application may attempt to set proximity parameters to maximize use of discovery.

Signaling between a mobile device and a network proximity server may use NAS capabilities and NAS signaling already defined by 3GPP. The network proximity server may also obtain information on a mobile device from the eNodeB and/or MME. Location related information may be obtained from an E-SMLC and/or from mobile devices. A network proximity server may communicate directly with a mobile device (through a MME and an eNodeB), directly with a eNodeB (through a MME) or to an MME. The network proximity server may by logically separate from a E-SMLC but physically combined to benefit from proximity and location synergies.

A network proximity server address may be discovered by a mobile device (e.g., using DHCP) or may be provided to the mobile device during network attachment or connection to a PDG. In some embodiments, a network proximity server uses a SUPL SLP to assist with mobile device location.

Proximity may be a function of roaming status. For example, just those mobile device that are not roaming participate in proximity detection.

Mobile-to-mobile proximity may be discovered in different ways. For example, a mobile device may send a broadcast. A mobile device may measure RTT to determine potential radio proximity and geographic proximity. Mobile devices may exchange proximity data to verify proximity. A mobile device may continue to monitor proximity for nearby mobile devices.

A mobile device may periodically provide a network proximity server with identifying data for each proximity group the mobile device belongs to (and optionally data for other mobile devices it has discovered. A network proximity server may broadcast proximity related data for many mobile devices and a receiving mobile device may determine its proximity. Alternative, a network proximity server may discover proximity within each group itself and send data point to point to mobile devices discovered to be in proximity in each proximity group. A mobile device may send proximity group identifiers and proximity data to the network proximity server. The network proximity server may broadcast proximity data to several mobile devices. A network proximity server may send a point-to-point message containing proximity data to a mobile device.

A proximity engine or process in a mobile device may manage interactions with other mobile devices and interaction with a network proximity server.

In some embodiments, an application may activate and deactivate proximity support for a particular proximity group. For activation, the application may provide data comprising a group ID and allowed discovery directions for mobile devices. Expressions for radio proximity may be derived by a proximity engine using data received from the application. The proximity engine may obtain location from a location engine. The network proximity engine may notify an application when proximity to other mobile devices within a group is starts or ends. An application may then decide how to react (e.g., notify the user, establish a data session, establish an IMS session, or exchange instant messaging).

Proximity information may be useful for and used by an indoor mapping or an indoor location application (e.g., providing indoor location maps and navigation and directions).

Proximity to another mobile device alerts a user or application when services or the other mobile device of interest are nearby. An application may provide directions to from one proximate user to proximate user. Venues (e.g., shopping mall, airport, hospital, library) may receive information on mobile devices in proximity and in response send advertising and/or assistance to users (e.g., inform nearby users at an airport when boarding has commenced for an intended flight).

The following step may help to enable more efficient support of discovery by a network server proximity (i.e., without excessive network load). First, a network may charge more for proximity services that require network support. Second, a network may set latency values higher (e.g., allow up to 5 minutes to detect proximity or dynamically adjust latency according to network load. Third, a network may force lower priority mobile devices and/or lower priority services to reducing distance parameters defining various proximities.

To use a network more efficient, a mobile device may exchange proximity information when the mobile device communicates with the server for some other reason (e.g., when registering at a new location). Mobile device proximity data can also be piggybacked on other network signaling (e.g., TAU, UE triggered service request forwarded by an MME). A MME may periodically provide a list of all attached mobile devices to a proximity server together with either the serving eNodeB IDs for mobile devices in a connected state or the TAs for UEs in idle state. MMEs may also provide mobile device IDs (e.g. temporary IDs) and proximity subscription information to a server when a mobile device first attaches or performs a TAU to a new MME. Either the server or MME could periodically poll mobile devices for location information and current proximity data (e.g., data for proximity groups currently activated by an application of the mobile device). Alternative, mobile devices may periodically push this information where a server replies with a preferred periodicity for future updates from the mobile device. The proximity server may then use serving cells or serving eNodeBs or Tracking Areas (TAs for cellular discovery) to detect coarse proximity as an over estimate of real proximity.

In some embodiments, an MME provides proximity subscription data for each mobile device following attachment to a network by a mobile device. In some embodiments, a mobile device provides proximity data initially and each time the proximate data changes. With regards to a mobile device, the proximity data may change as users activate and deactivate applications, which in turn activate, deactivate and modify proximity data for different proximity groups (e.g., via a proximity engine). Proximity data changes for a proximity group may be infrequent if users typically maintain a default profile of active proximity services.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method, in a mobile device, to determine a combined proximity result for two transceivers, the method comprising:
determining results for at least two types of proximity from a group comprising:
geographic proximity;
radio proximity; and
cellular proximity; and
determining the combined proximity result by logically combining the results for the at least two types of proximity.

2. The method of claim 1, wherein the geographic proximity comprises a distance between the mobile device and at least one mobile device of less than a threshold distance.

3. The method of claim 2, wherein the threshold distance is a function of location.

4. The method of claim 2, wherein the threshold distance is a function of an application.

5. The method of claim 2, wherein the threshold distance is a function of a time of day.

6. The method of claim 1, wherein the radio proximity comprises an RSSI (received signal strength indicator) the mobile device and at least one mobile device greater than a threshold level.

7. The method of claim 1, wherein the geographic proximity comprises an RTT (round-trip time) the mobile device and at least one mobile device less than a threshold time.

8. The method of claim 1, wherein the cellular proximity comprises two mobile stations being serviced by a common cell.

9. The method of claim 1, wherein the cellular proximity comprises two mobile stations having coverage of a common cell.

10. The method of claim 1, wherein logically combining comprises a union of the results for the at least two types of proximity.

11. The method of claim 1, wherein logically combining comprises an intersection of the results for the at least two types of proximity.

12. The method of claim 1, wherein the combined proximity result comprises determining the two transceivers are proximate.

13. The method of claim 1, wherein the combined proximity result comprises determining the two transceivers are not proximate.

14. The method of claim 1, wherein determining results for the at least two types of proximity comprises determining a lack of proximity from at least one of the geographic proximity, the cellular proximity, and the radio proximity.

15. The method of claim 1, further comprising applying the combined proximity result to an application.

16. The method of claim 1, further comprising reporting the combined proximity result.

17. The method of claim 16, wherein reporting the combined proximity result comprises reporting the combined proximity result to a server.

18. The method of claim 16, wherein reporting the combined proximity result comprises reporting the combined proximity result to a second mobile device.

19. The method of claim 16, wherein reporting the combined proximity result comprises reporting the combined proximity result to a transceiver in direct proximity.

20. The method of claim 16, wherein reporting the combined proximity result comprises reporting the combined proximity result a transceiver in indirect proximity.

21. A mobile device to determine a combined proximity result for two transceivers, the mobile device comprising:
at least two modules for determining results for at least two types of proximity, respectively, the at least two modules from a group comprising:
a geographic proximity module to determine a geographic proximity;
a radio proximity module to determine a radio proximity; and
a cellular proximity module to determine a cellular proximity; and
a logical combiner coupled to each of the at least two modules, wherein the logical combiner logically combines proximity results to determine the combined proximity result.

22. The mobile device of claim 21, wherein the geographic proximity comprises a distance the mobile device and at least one mobile device of less than a threshold distance.

23. The mobile device of claim 21, wherein the radio proximity comprises an RSSI (received signal strength indicator) the mobile device and at least one mobile device greater than a threshold level.

24. The mobile device of claim 21, wherein the geographic proximity comprises an RTT (round-trip time) the mobile device and at least one mobile device less than a threshold time.

25. The mobile device of claim 21, wherein the cellular proximity comprises two mobile stations being serviced by a common cell.

26. The mobile device of claim 21, wherein the logical combiner comprises a union module for calculating a union of the results for the at least two types of proximity.

27. The mobile device of claim 21, wherein the logical combiner comprises an intersection module for calculating an intersection of the results for the at least two types of proximity.

28. The mobile device of claim 21, further comprising a reporter coupled to the logical combiner and to report the combined proximity result on the mobile device, wherein the mobile device comprises one of the two transceivers.

29. The mobile device of claim 21, further comprising a reporter coupled to the logical combiner, wherein the reporter is configured to report the combined proximity result to a farther away one of the two transceivers.

30. A mobile device to determine a combined proximity result for two transceivers, the mobile device comprising:
means for determining results for at least two types of proximity, from of a group comprising:
geographic proximity;
radio proximity; and
cellular proximity; and
means for logically combining proximity results to determine the combined proximity result.

31. The mobile device of claim 30, wherein the geographic proximity comprises a distance the mobile device and at least one mobile device of less than a threshold distance.

32. The mobile device of claim 30, wherein the radio proximity comprises an RSSI (received signal strength indicator) the mobile device and at least one mobile device greater than a threshold level.

33. The mobile device of claim 30, wherein the geographic proximity comprises an RTT (round-trip time) the mobile device and at least one mobile device less than a threshold time.

34. The mobile device of claim 30, wherein the cellular proximity comprises two mobile stations being serviced by a common cell.

35. The mobile device of claim 30, wherein the means for logically combining comprises means for determining a union of the results for the at least two types of proximity.

36. The mobile device of claim 30, wherein the means for logically combining comprises means for determining an intersection of the results for the at least two types of proximity.

37. The mobile device of claim 30, further comprising means for reporting the combined proximity result to a closer one of the two transceivers.

38. The mobile device of claim 30, further comprising means for reporting the combined proximity result to a farther away one of the two transceivers.

39. A non-transient computer-readable storage medium including program code stored thereon to determine a combined proximity result for two transceivers, comprising program code to:
determine results for at least two types of proximity from a group comprising:
geographic proximity;
radio proximity; and
cellular proximity;
logically combine the results for the at least two types of proximity to form the combined proximity result.

40. The non-transient computer-readable storage medium of claim 39, wherein the geographic proximity comprises a distance the mobile device and at least one mobile device of less than a threshold distance.

41. The non-transient computer-readable storage medium of claim 39, wherein the radio proximity comprises an RSSI (received signal strength indicator) the mobile device and at least one mobile device greater than a threshold level.

42. The non-transient computer-readable storage medium of claim 39, wherein the geographic proximity comprises an RTT (round-trip time) the mobile device and at least one mobile device less than a threshold time.

43. The non-transient computer-readable storage medium of claim 39, wherein the cellular proximity comprises two mobile stations being serviced by a common cell.

44. The non-transient computer-readable storage medium of claim 39, wherein the program code to logically combine the results for the at least two types of proximity comprises program code to form a union of the results for the at least two types of proximity.

45. The non-transient computer-readable storage medium of claim 39, wherein the program code to logically combine the results for the at least two types of proximity comprises program code to form an intersection of the results for the at least two types of proximity.

46. The non-transient computer-readable storage medium of claim 39, further comprising program code to report the combined proximity result to a closer one of the two transceivers.

47. The non-transient computer-readable storage medium of claim 39, further comprising program code to report the combined proximity result to a more distant one of the two transceivers.

48. A method to determine proximity of two transceivers, the method comprising:
determining a coarse proximity result;
determining a fine proximity result based on the coarse proximity result being proximate; and
determining a combined proximity result based on the fine proximity result.

49. The method of claim 48, further comprising:
determining a second coarse proximity result; and
changing a combined proximity result based on the second coarse proximity result being not proximate.

50. The method of claim 48, wherein the fine proximity result comprises a finding of not proximate, and wherein setting the combined proximity result based on the fine proximity result comprises setting the combined proximity result to not proximate.

51. The method of claim 48, wherein the fine proximity result comprises a finding of proximate, and wherein setting the combined proximity result based on the fine proximity result comprises setting the combined proximity result to proximate.

52. The method of claim 48, further comprising applying the combined proximity result to an application.

53. The method of claim 48, further comprising reporting the combined proximity result.

54. A mobile device to determine proximity of two transceivers, the mobile device comprising:
a transceiver;
a processor coupled to the transceiver, wherein the processor contains code to:
determine, by a coarse proximity test, a coarse proximity result;
determine, by a fine proximity test, a fine proximity result based on the coarse proximity result being proximate; and
determine, with a logical combinder a combined proximity result based on the fine proximity result.

55. The mobile device of claim 54, wherein the fine proximity test results in a finding of not proximate, and wherein the logical combiner sets the combined proximity result based on the fine proximity result comprises logic to set the proximity to not proximate.

56. The mobile device of claim 54, wherein the fine proximity test results in a finding of proximate, and wherein the logical combiner to determine the combined proximity result based on the fine proximity result comprises logic to set the proximity to proximate.

57. The mobile device of claim 54, wherein the processor further contains code to report the combined proximity result.

58. A device to determine proximity of two transceivers, the device comprising:
means for determining a coarse proximity result;
means for determining a fine proximity result based on the coarse proximity result being proximate; and
means for determining a combined proximity result based on the fine proximity result.

59. The device of claim 58, further comprising:
means for determining a second coarse proximity result; and
means for changing the combined proximity result, based on the second coarse proximity result being not proximate.

60. The device of claim 58, wherein the fine proximity result comprises a finding of not proximate, and wherein setting the proximity based on the fine proximity result comprises setting the combined proximity result to not proximate.

61. The device of claim 58, wherein the fine proximity result comprises a finding of proximate, and wherein setting the proximity based on the fine proximity result comprises setting the combined proximity result to proximate.

62. The device of claim 58, further comprising means for applying the combined proximity result to an application.

63. The device of claim 58, further comprising means for reporting the combined proximity result.

64. A non-transient computer-readable storage medium including program code stored thereon to determine proximity of two transceivers, comprising program code to:
determine a coarse proximity result;
determine a fine proximity result based on the coarse proximity result being proximate; and
determine a combined proximity result based on the fine proximity result.

65. The non-transient computer-readable storage medium of claim 64, further comprising program code to:
determine a second coarse proximity result; and
change the combined proximity result, based on the second coarse proximity result being not proximate.

66. A method to determine proximity of two transceivers, the method comprising:
determining a first proximity result between a first transceiver and a second transceiver;
determining a second proximity result between the second transceiver and a third transceiver;
determining a third proximity result between the first transceiver and the third transceiver based on the first proximity result and the second proximity result.

67. The method of claim 66, wherein determining the first proximity result comprises determining a first geographic proximity and determining the second proximity result comprises determining a second geographic proximity.

68. The method of claim 66, wherein determining the first proximity result comprises determining a first radio proximity and determining the second proximity result comprises determining a second radio proximity.

69. The method of claim 66, wherein determining the first proximity comprises determining a first cellular proximity and determining the second proximity result comprises determining a second cellular proximity.

70. The method of claim 66, wherein determining the first proximity and determining the second proximity result both comprise determining proximity results for at least two types of proximity from a group comprising:
geographic proximity;
radio proximity; and
cellular proximity.

71. The method of claim 66, wherein determining the first proximity and determining the second proximity result both comprise determining a lack of proximity for at least one of at least two types of proximity.

72. The method of claim 66, further comprising applying a combined proximity result to an application.

73. The method of claim 66, wherein the first transceiver, the second transceiver and the third transceiver comprise three mobile stations.

74. A mobile device to determine proximity of two transceivers, the mobile device comprising:
logic for determining a first proximity result between a first transceiver and a second transceiver;
logic for determining a second proximity result between the second transceiver and a third transceiver;
logic for determining a third proximity result between the first transceiver and the third transceiver based on the first proximity result and the second proximity result.

75. The mobile device of claim 74, wherein determining the first proximity result comprises determining a first geographic proximity and determining the second proximity result comprises determining a second geographic proximity.

76. The mobile device of claim 74, wherein the logic for determining the first proximity result comprises logic for determining a first radio proximity and logic for determining the second proximity result comprises determining a second radio proximity.

77. The mobile device of claim 74, wherein the logic for determining the first proximity result comprises logic for determining a first cellular proximity and logic for determining the second proximity result comprises determining a second cellular proximity.

78. A mobile device to determine proximity of two transceivers, the mobile device comprising:
means for determining a first proximity result between a first transceiver and a second transceiver;
means for a determining second proximity result between the second transceiver and a third transceiver;
means for determining a third proximity result between the first transceiver and the third transceiver based on the first proximity result and the second proximity result.

79. The mobile device of claim 78, wherein the means for determining the first proximity result comprises means for determining a first geographic proximity and means for determining the second proximity result comprises determining a second geographic proximity.

80. The mobile device of claim 78, wherein the means for determining the first proximity result comprises means for determining a first radio proximity and means for determining the second proximity result comprises determining a second radio proximity.

81. The mobile device of claim 78, wherein the means for determining the first proximity result comprises means for determining a first cellular proximity and means for determining the second proximity result comprises determining a second cellular proximity.

82. A non-transient computer-readable storage medium including program code stored thereon to determine proximity of two transceivers, comprising program code to:
determine a first proximity result between a first transceiver and a second transceiver;
determine a second proximity result between the second transceiver and a third transceiver;
determine a third proximity result between the first transceiver and the third transceiver based on the first proximity result and the second proximity result.

83. The non-transient computer-readable storage medium of claim 82, wherein the program code to determine the first proximity result comprises program code to determine a first geographic proximity and program code to determine the second proximity result comprises determining a second geographic proximity.

84. The non-transient computer-readable storage medium of claim 82, wherein the program code to determine the first proximity result comprises program code to determine a first radio proximity and program code to determine the second proximity result comprises determining a second radio proximity.

85. The non-transient computer-readable storage medium of claim 82, wherein the program code to determine the first proximity result comprises program code to determine a first cellular proximity and program code to determine the second proximity comprises result determining a second cellular proximity.
